(19) United States
(12) Patent Application Publication
(10) Pub. No.: US 2004/0252246 A1
(43) Pub. Date: Dec. 16, 2004

(54) TV signal receiving module and portable computer having the same

(75) Inventor: Kwang-yong Lee, Suwon City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/820,881

(22) Filed: Apr. 9, 2004

(30) Foreign Application Priority Data
Jun. 12, 2003 (KR) 2003-38002

(51) Int. Cl. H04N 7/00

(52) U.S. Cl. 348/725

(57) ABSTRACT

A TV signal receiving module and method thereof is connected to a portable computer through a USB (universal serial bus) connector or a USB external connection terminal, and includes a tuner, a video decoder, an audio decoder, an encoding engine, and a network connecting part. The tuner receives an analog or a digital signal and separates the analog signal into a video signal and an audio signal and converting the digital signal into a first data stream. The video decoder converts the video signal of the analog signal into a digital video stream. The audio decoder converts the audio signal of the analog into a digital audio stream. The encoding engine encodes the digital video and audio streams into a second data stream. The network connecting part converts a format of the first data stream or the second data stream for the portable computer.

### CROSS-REFERENCE TO RELATED APPLICATIONS

This application claims the benefit of Korean Patent Application No. 2003-38002, filed Jun. 12, 2003, in the Korean Intellectual Property Office, the disclosure of which is incorporated herein by reference.

### BACKGROUND OF THE INVENTION

1. Field of the Invention

The present invention relates to a TV signal receiving module of a portable computer and a portable computer having the same, and more particularly, to a TV signal receiving module and a portable computer having the same, in which the TV signal receiving module receives both analog and digital TV signals, and the TV signal receiving module is connected to and recognized by the portable computer while the portable computer operates and is selectively used as internal and external types.

2. Description of the Related Art

A TV card is a type of TV signal receiving module and is employed in a computer system, particularly in a personal computer, to allow a user to watch TV.

As one of the TV cards, an analog TV/PVR (personal video recorder) card converts/encodes an analog TV signal received through an antenna provided in an NTSC (national television standards committee) tuner into a digital signal, and transmits the digital signal to the computer system through a PCI (peripheral component interconnect) bus, so that the digital signal is displayed on a display device.

Similarly, a digital TV card bypasses an NTSC component of a TV signal received through a NTSC/ATSC (advanced television system committee) tuner, demodulates/restores an ATSC component of the TV signal into the digital signal, and then transmits the digital signal to the computer system through the PCI bus, so that the digital signal is displayed on the display device.

Including the above TV cards, most TV cards recently being in wide use have a PCI interface, which allows the TV card to be inserted in a slot provided in a main board of a computer to allow the user to watch TV on the computer.

However, such TV cards using the PCI interface should be already connected to the computer system before booting the computer; otherwise, the computer cannot recognize the TV card. Hence, the conventional TV signal receiving module does not offer a Hot-Plug functionality, which gives the user an ability to connect the TV card to the computer system without having to power-off the computer or suspend any applications.

Further, in the computer, particularly in a portable computer, a tendency is toward reducing a size of the main board, thereby making it difficult to mount both the analog and digital TV cards onto the main board.

### SUMMARY OF THE INVENTION

Accordingly, it is an aspect of the present invention to provide a TV signal receiving module and a portable computer having the same, in which the TV signal receiving module can be used for both analog and digital TV signals, and selectively used as internal and external types.

Another aspect of the present invention is to provide a TV signal receiving module and a portable computer having the same, in which the TV signal receiving module can be connected to and recognized by the portable computer while the portable computer operates.

Additional aspects and/or advantages of the invention will be set forth in part in the description which follows and, in part, will be obvious from the description, or may be learned by practice of the invention.

The foregoing and/or other aspects of the present invention are achieved by providing a TV signal receiving module of a portable computer including a tuner to receive an analog TV signal and a digital TV signal; a video decoder to receive and process a video signal divided from the analog TV signal received by the tuner so as to display a picture based on the video signal; an encoding engine to encode the video signal processed in the video decoder having a predetermined format; a memory to store the encoded video signal having the predetermined format; and a network connecting part to control the digital TV signal and the encoded video signal to be transmitted to the portable computer.

According to an aspect of the invention, the network connecting part controls the digital TV signal and the encoded video signal to be transmitted to the portable computer through a USB.

According to an aspect of the invention, the network connecting part individually controls the digital TV signal and the encoded video signal to be transmitted to the portable computer through the USB.

According to an aspect of the invention, the network connecting part controls the digital TV signal and the encoded video signal to be transmitted to the portable computer through only one USB.

According to an aspect of the invention, the TV signal receiving module has an external shape suitable for being mounted to a battery mounting place of the portable computer.

According to an aspect of the invention, the portable computer has a TV module connection terminal to which the TV signal receiving module is connected, wherein the TV module connection terminal is separated from and is adjacent to a battery terminal to which the battery is connected. Therefore, the TV signal receiving module is connected to the portable computer through the TV module connection terminal, thereby transmitting the TV signal to the portable computer.

According to an aspect of the invention, the TV signal receiving module further includes an external connection terminal allowing the TV signal receiving module to be connected to the portable computer.

According to another aspect of the present invention, the above and/or other aspects may be also achieved by providing a portable computer having a TV signal receiving module which includes a tuner to receive an analog TV signal and a digital TV signal; a video decoder to receive and process a video signal divided from the analog TV signal received by the tuner so as to display a picture based on the video signal; an encoding engine to encode the video signal processed in the video decoder having a predetermined format; a memory to store the encoded video signal having the predetermined format; and a network connecting part to control the digital TV signal and the encoded video signal to be transmitted to the portable computer.

According to an aspect of the invention, the portable computer further includes a TV module connection terminal to which the TV signal receiving module is connected, wherein the TV module connection terminal is separated from and adjacent to a battery terminal to which the battery is connected. Therefore, the TV signal receiving module is connected to the portable computer through the TV module connection terminal, thereby transmitting the TV signal to the portable computer.

According to an aspect of the present invention, there is further provided, a TV signal receiving module connected to a portable computer through a USB (universal serial bus) connector or a USB external connection terminal, the TV signal receiving module including: a tuner receiving an analog signal and separating the analog signal into a video signal and an audio signal or receiving a digital signal and converting the digital signal into a first data stream; a video decoder converting the video signal into a digital video stream; an audio decoder converting the audio signal into a digital audio stream; an encoding engine encoding the digital video and audio streams into a second data stream; and a network connecting part converting a format of the first data stream or the second data stream for the portable computer.

According to an aspect of the present invention, there is further provided, an operating method of a TV signal receiving module connected to a portable computer through a USB (universal serial bus) port, the operating method including: receiving an analog or a digital signal; separating the analog signal into a video signal and an audio signal; converting the digital signal into a first data stream; converting the video signal and the audio signal into a digital video stream and a digital audio stream, respectively; encoding the digital video and audio streams into a second data stream; and converting a format of the first data stream or the second data stream for the potable computer

### BRIEF DESCRIPTION OF THE DRAWINGS

These and/or other aspects and advantages of the present invention will become apparent and more readily appreciated from the following description of the aspects, taken in conjunction with the accompany drawings of which:

FIG. 1 is a block diagram of a TV signal receiving module, according to an aspect of the present invention;

FIG. 2 illustrates a configuration of the TV signal receiving module, according to an aspect of the present invention;

FIG. 3 is a perspective view of the TV signal receiving module of FIG. 2;

FIG. 4A illustrates the TV signal receiving module mounted within a portable computer, according to an aspect of the present invention; and

FIG. 4B illustrates the TV signal receiving module connected to the portable computer through a cable, according to an aspect of the present invention.

### DETAILED DESCRIPTION OF THE PREFERRED EMBODIMENTS

Reference will now be made in detail to the aspects of the present invention, examples of which are illustrated in the accompanying drawings, wherein like reference numerals refer to the like elements throughout. The aspects are described below to explain the Present invention by referring to the figures.

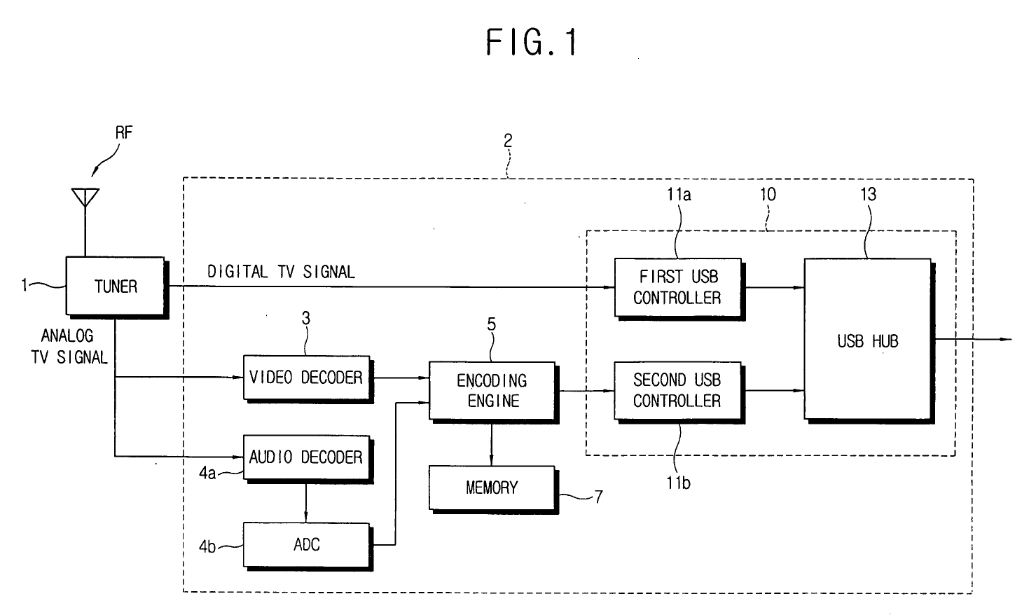

FIG. 1 is a block diagram of a TV signal receiving module, according to an aspect of the present invention. As shown therein, the TV signal receiving module according to the present invention includes a tuner 1, and a TV signal processing module 2, which includes a video decoder 3, an encoding engine 5, a memory 7, and a network connecting part 10 including a first USB (universal serial bus) controller 11a, a second USB controller 11b, and a USB hub 13. In an aspect according to the present invention, the TV signal receiving module may further include an audio decoder 4a, and an ADC (analog/digital converter) 4b.

Here, the video decoder 3, the audio decoder 4a, the ADC 4b, and the encoding engine 5 are employed to decode, to restore, and to encode a signal into a digital signal suitable for a portable computer.

The tuner 1 is an ATSC/NTSC compatible tuner, and is employed to select and to receive a TV signal at a specific channel from a broadcasting station. That is, the tuner 1 selects and receives the TV signal at a specific frequency from the broadcasting station. Here, ATSC (advanced television system committee) is a standard for digital television, and NTSC (national television standards committee) is a standard for analog television. According to the present invention, the tuner 1 can be used for both the analog and the digital television.

In the case of the NTSC, the tuner 1 separates an analog TV signal into a video signal and an audio signal, and converts the video signal and the audio signal into a CVBS (composite video burst sync) signal and a 2nd IF (intermediate frequency) signal, respectively.

The tuner 1 transmits the CVBS signal as the video signal to the video decoder 3, and the 2nd IF signal as the audio signal to the audio decoder 4a.

The video decoder 3 converts the CVBS signal received from the tuner 1 into a digital video stream “CCIR656,” and transmits the digital video stream “CCIR656” to the encoding engine 5. The encoding engine 5 may be an MPEG (moving picture experts group)-2 encoder.

The audio decoder 4a converts the 2nd IF signal received from the tuner 1 into a digital audio stream “I²S,” and transmits the digital audio stream “I²S” to the encoding engine 5 through the ADC 4b.

The encoding engine 5 encodes the digital video and audio streams received from the video and audio decoders 3 and 5, respectively, into a first data stream, and the first data stream may be an MPEG-2 program stream for efficient storage.

The memory 7 is employed as a storage unit to store information of a picture to be displayed on a display part of the portable computer. Therefore, the digital video and audio streams encoded by the encoding engine 5 are stored as the information of the picture in the memory 7. The information is transmitted to a graphic card (not shown), thereby displaying the picture on the display part.

Thus, in the case of the NTSC, the analog TV signal is encoded into the MPEG-2 program stream through the video decoder 3, the audio decoder 4a, the ADC 4b and the encoding engine 5, and then transmitted to the second USB controller 11b.

Oppositely, in the case of the ATSC, a digital TV signal is converted into a second data stream, and the second data stream may be an MPEG-2 transport stream in the tuner 1, and then directly transmitted to the first USB controller 11a.

The first USB controller 11a converts a format of the second data stream of the ATSC suitably for a USB, and the second USB controller 11b converts the format of the first data stream of the NTSC suitably for the USB.

The TV signal, of which the format is converted suitably for the USB by the first and second USB controllers 11a and 11b, is output through a USB connector or a USB external connection terminal (to be described later) provided in the TV signal receiving module.

Here, the USB connector or the USB external connection terminal can be individually provided for the first and second USB controllers 11a and 11b. However, according to an aspect of the present invention, only one USB connector or USB external connection terminal is provided for the first and second USB controllers 11a and 11b, so that the TV signal receiving module is readily mounted and connected to the portable computer.

To achieve the foregoing and/or other aspects of the present invention, there is provided the USB hub 13 to receive the converted first data stream and second data stream from the first and second USB controllers 11a and 11b, respectively. The converted first data stream and second data stream are transmitted to the USB connector or the USB external connection terminal through the USB hub 13.

Here, the video decoder 3, the audio decoder 4a, the ADC 4b, the encoding engine 5, the first USB controller 11a, the second USB controller 11b, and the USB hub 13 can be achieved using integrated circuits or chips, respectively.

With a configuration of the TV signal receiving module described above, the TV signal receiving module according to an aspect of the present invention receives both the analog TV signal of the NTSC and the digital TV signal of the ATSC. Therefore, a user can select either of the NTSC or the ATSC, and only the selected TV signal is displayed.

Further, according to an aspect of the present invention, because the TV signal receiving module is connected to the portable computer and not through a PCI interface but through the USB, the TV signal receiving module can be connected to and recognized by the portable computer while the portable computer operates.

Furthermore, according to an aspect of the present invention, the TV signal receiving module can be readily connected to the portable computer without being inserted into a slot of a main board. According to an aspect of the present invention, the TV signal receiving module is not limited to a board shape corresponding to the slot and may be designed in various shapes.

Due to the easy connection between the TV signal receiving module and the portable computer, the TV signal receiving module may be designed to be internally mounted into a battery mounting place provided in the portable computer, an aspect of which will be described hereinbelow.

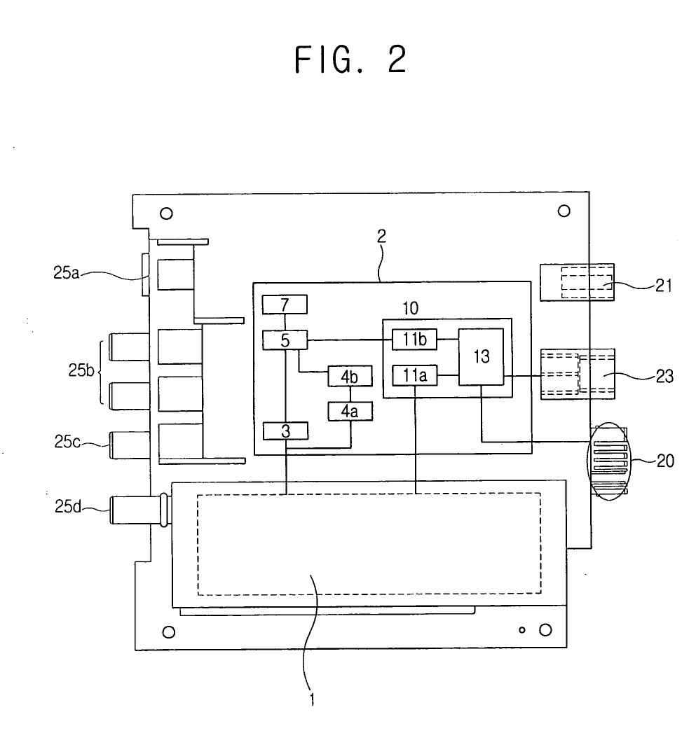

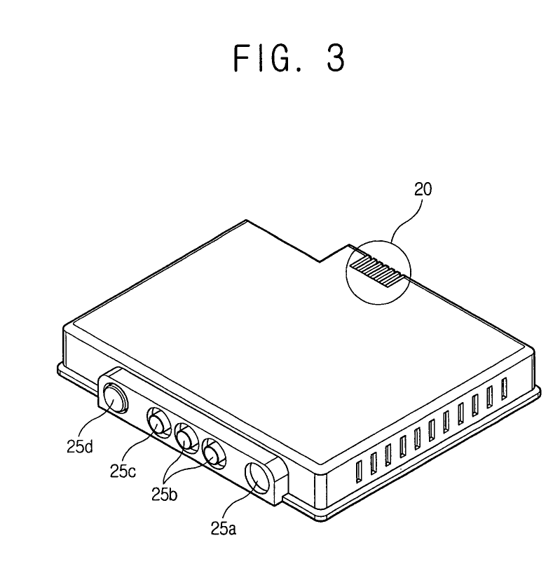

FIG. 2 illustrates a configuration of the TV signal receiving module, according to an aspect of the present invention, and FIG. 3 is a perspective view of the TV signal receiving module of FIG. 2. As shown in FIGS. 2 and 3, the TV signal receiving module has an external shape suitable for being mounted to the battery mounting place of the portable computer.

Considering that a shape of the battery for different portable computers may vary, according to an aspect of the present invention, a shape of the TV signal receiving module may correspond to the shape of the battery so as to stably mount the TV signal receiving module to the portable computer. However, the TV signal receiving module may be smaller than the battery.

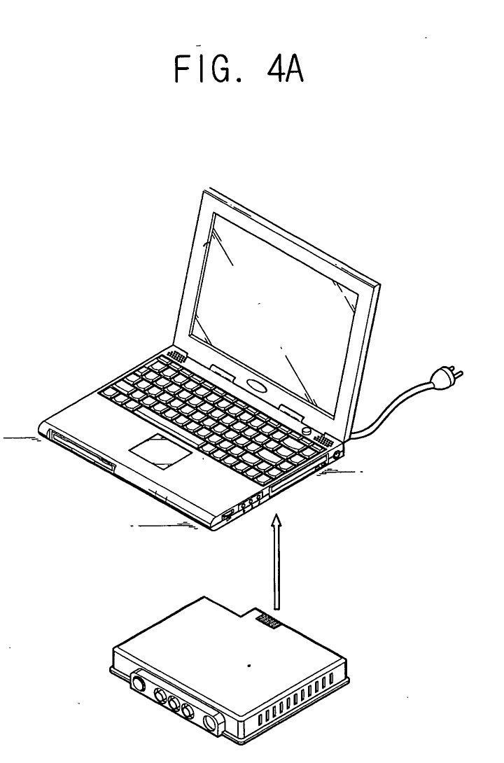

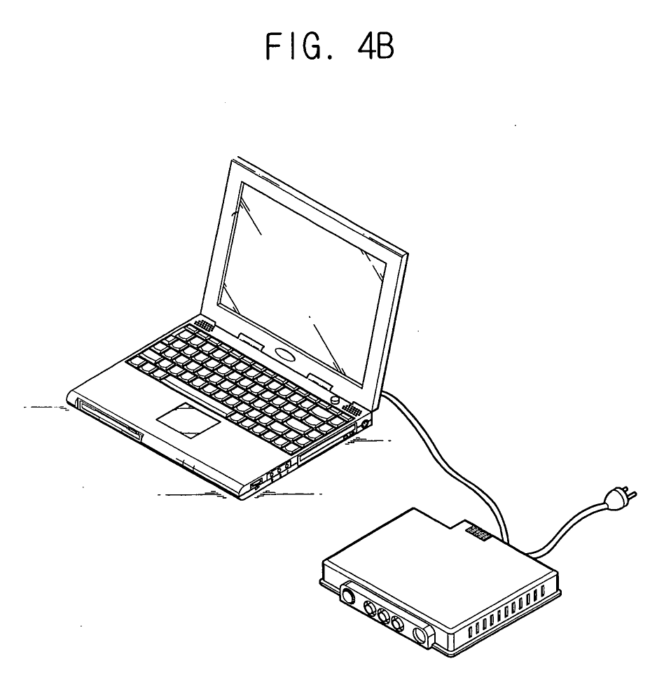

On one side of the TV signal receiving module a connector 20, a power input terminal 21, and an external connection terminal 23 are provided. The connector 20 is directly connected to a USB port that is disposed in the bottom of the portable computer and adjacent to a connector to which the battery is connected. Electric power is supplied through the power input terminal 21 to components of the TV signal receiving module (i.e., a tuner 1, a video decoder 3, an encoding engine 5, a memory 7, and a network connecting part 10). The external connection terminal 23 is indirectly connected to a USB port that is disposed in the back of the portable computer through a cable or the like (refer to FIG. 4B).

On the other side of the TV signal receiving module the following are provided: a plurality of input terminals including an S-video input terminal 25a, two stereo terminals 25b for the audio signal, a video input terminal 25c, and a TV signal receiving antenna 25d connected to the tuner 1.

The TV signal processing module 2, excluding the tuner 1 from the TV signal receiving module, is connected to the tuner 1 so as to input the analog TV signal received through the tuner 1 to the video and audio decoders 3 and 4a, and to transmit the digital TV signal received through the tuner 1 to the first USB controller 11a.

Further, the video decoder 3 is connected to the S-video input terminal 25a and the video input terminal 25c.

A disposition of the chips of the TV signal processing module 2 is not limited to the accompanying drawings, and can vary as long as the above described connection is kept.

As shown in FIG. 4A, the connector 20 is used as a connection terminal to mount the TV signal receiving module to the portable computer. Also, in the bottom of the portable computer, a TV module connection terminal to which the connector 20 is connected is also provided. According to an aspect of the present invention, in the portable computer, the TV module connection terminal corresponding to the connector 20 of the TV signal receiving module is separated from and is adjacent to a battery terminal corresponding to the connector of the battery.

On the other hand, in the case that the TV signal receiving module is mounted to the battery mounting place of the portable computer instead of the battery, the portable computer may receive the electric power from a commercial AC (alternating current) power source because the battery is not connected thereto.

Further, as shown in FIG. 4A, because the TV signal receiving module is mounted to the bottom of the portable computer, it is not easy to supply the electric power through the power input terminal 21. In this case, a plurality of pins of the connector 20 are partly connected to the USB port of the portable computer and partly connected to a power pin of the portable computer.

As shown in FIG. 4B, the external connection terminal 23 is used when the TV signal receiving module is connected to the USB port of the portable computer through the cable or the like. In this case, the portable computer can receive the electric power from the battery as well as the commercial AC power source. At this time, the TV signal receiving module may receive the electric power from the commercial AC power source through the power input terminal 21.

As described above, according to an aspect of the present invention, there is provided a TV signal receiving module and a portable computer having the same, in which the TV signal receiving module can be used for both an analog TV signal of NTSC and a digital TV signal of ATSC.

Further, according to an aspect of the present invention, there is provided a TV signal receiving module and a portable computer having the same, in which the TV signal receiving module is connected to the portable computer, not through a PCI interface, but through a USB, so that the TV signal receiving module can be connected to and recognized by the portable computer while the portable computer operates.

Furthermore, according to an aspect of the present invention, there is provided a TV signal receiving module and a portable computer having the same, in which the TV signal receiving module can be readily connected to the portable computer without being inserted in a slot of a main board. Accordingly, the TV signal receiving module is not limited to a board shape corresponding to the slot, and can be designed in various shapes, particularly, the TV signal receiving module can be designed to be internally mounted to a battery mounting place of the portable computer.

Although a few aspects of the present invention have been shown and described, it will be appreciated by those skilled in the art that changes may be made in these aspects without departing from the principles and spirit of the invention, the scope of which is defined in the appended claims and their equivalents.

What is claimed is:

1. A TV signal receiving module, the TV signal receiving module comprising:
a tuner receiving an analog signal and separating the analog signal into a video signal and an audio signal or receiving a digital signal and converting the digital signal into a first data stream;
a video decoder converting the video signal of the analog signal into a digital video stream;
an audio decoder converting the audio signal into a digital audio stream;
an encoding engine encoding the digital video and audio streams into a second data stream; and
a network connecting part converting a format of the first data stream or the second data stream for the portable computer.

2. The TV signal receiving module as recited in claim 1, wherein the TV signal receiving module is connected to a portable computer through a USB connector or a USB external connection terminal.

3. The TV signal receiving module as recited in claim 1, wherein the first data stream comprises an MPEG-2 transport stream and the second data stream comprises an MPEG-2 program stream.

4. The TV signal receiving module as recited in claim 2, wherein the network connecting part comprises:
a first USB controller converting the format of the first data stream for the USB port, and
a second USB controller converting the format of the second data stream for the USB port.

5. The TV signal receiving module as recited in claim 2, wherein the network connecting part further comprises:
a USB hub receiving and transmitting the converted first data stream and the second data stream to the USB connector or the USB external connection terminal.

6. The TV signal receiving module as recited in claim 1, wherein the tuner converts the video signal and the audio signal into a CVBS (composite video burst sync) signal and a 2nd IF (intermediate frequency) signal, respectively.

7. The TV signal receiving module as recited in claim 6, further comprising:
an ADC (analog/digital converter), wherein the audio decoder converts the 2nd IF signal received from the tuner into the digital audio stream and transmits the digital audio stream to the encoding engine through the ADC.

8. The TV signal receiving module as recited in claim 7, wherein the video decoder, the audio decoder, the ADC, the encoding engine, the network connecting part are integrated circuits or chips.

9. The TV signal receiving module as recited in claim 1, further comprising:
a memory storing the digital video and audio streams of a picture to be displayed on a display part of the portable computer.

10. The TV signal receiving module as recited in claim 1, wherein the TV signal receiving module is connected to the portable computer without being inserted into a slot of a main board.

11. The TV signal receiving module as recited in claim 1, wherein the TV signal receiving module is internally mounted into a battery mounting place provided in the portable computer.

12. The TV signal receiving module as recited in claim 1, wherein a shape of the TV signal receiving module corresponds to a shape of a battery.

13. The TV signal receiving module as recited in claim 1, wherein the TV signal receiving module is smaller than a battery.

14. The TV signal receiving module as recited in claim 1, wherein the portable computer further comprises a USB port and a battery, and the TV signal receiving module further comprises:
a connector directly connected to the USB port of the portable computer that is disposed in a bottom of the portable computer and adjacent to a connector to which the battery is connected;
a power input terminal supplying electric power to the tuner, the video decoder, the encoding engine, and the network connecting part; and
an external connection terminal indirectly connected to the USB port that is disposed in a back section of the portable computer through a cable.

15. The TV signal receiving module as recited in claim 14, wherein the TV signal receiving module further comprises:
an S-video input terminal;
two stereo terminals for the audio signal;
a video input terminal, and
a TV signal receiving antenna connected to the tuner, wherein the video decoder is connected to the S-video input terminal and the video input terminal.

16. The TV signal receiving module as recited in claim 14, wherein the connector is used as a connection terminal to mount the TV signal receiving module to the portable computer.

17. The TV signal receiving module as recited in claim 14, wherein, in the portable computer, a TV module connection terminal corresponding to the connector of the TV signal receiving module is separated from and is adjacent to a battery terminal corresponding to a connector of the battery.

18. The TV signal receiving module as recited in claim 14, wherein pins of the connector are partly connected to the USB port of the portable computer and partly connected to a power pin of the portable computer to supply the electric power through the input terminal.

19. The TV signal receiving module as recited in claim 14, wherein the external connection terminal is used when the TV signal receiving module is connected to the USB port of the portable computer through the cable, allowing the portable computer to receive the electric power from the battery or from a commercial AC power source, where the TV signal receiving module receives the electric power from the commercial AC power source through the power input terminal.

20. The TV signal receiving module as recited in claim 1, wherein the encoding engine is an MPEG (moving picture experts group)-2 encoder.

21. The TV signal receiving module as recited in claim 1, wherein the tuner is an ATSC/NTSC compatible tuner.

22. A TV signal receiving module for a portable computer having a USB port and a battery mounting place, comprising:
an external shape that corresponds to a shape of a battery to be mounted to the battery mounting place of the portable computer.

23. The TV signal receiving module as recited in claim 22, further comprising:
a tuner receiving an analog TV signal and a digital TV signal;
a video decoder receiving and processing a video signal divided from the analog TV signal so as to display a picture based on the video signal;
an encoding engine encoding the video signal processed in the video decoder having a predetermined format; and
a network connecting part controlling the digital TV signal and the encoded video signal to be transmitted to the portable computer.

24. The TV signal receiving module as recited in claim 23, further comprising:
a connector directly connected to the USB port of the portable computer that is disposed in a bottom of the portable computer and adjacent to a connector to which the battery is connected;
a power input terminal supplying electric power to the tuner, the video decoder, the encoding engine, and the network connection part; and
an external connection terminal indirectly connected to the USB port that is disposed in a back section of the portable computer through a cable.

25. An operating method of a TV signal receiving module connected to a portable computer through a USB (universal serial bus) port, the operating method comprising:
receiving an analog or a digital signal;
separating the analog signal into a video signal and an audio signal;
converting the digital signal into a first data stream;
converting the video signal and the audio signal into a digital video stream and a digital audio stream, respectively;
encoding the digital video and audio streams into a second data stream; and
converting a format of the first data stream or the second data stream for the portable computer.

26. The method of the TV signal receiving module as recited in claim 25, wherein the first data stream comprises an MPEG-2 transport stream and the second data stream comprises an MPEG-2 program stream.

27. The method of the TV signal receiving module as recited in claim 25, wherein because the TV signal receiving module is connected to the portable computer, not through a PCI interface, but through the USB port, further comprising:
recognizing the TV signal receiving module while the portable computer operates.

28. A portable computer having a TV signal receiving module which includes
a tuner to receive an analog TV signal and a digital TV signal;
a video decoder to receive and process a video signal divided from the analog TV signal received by the tuner so as to display a picture based on the video signal;
an encoding engine to encode the video signal processed in the video decoder having a predetermined format;
a memory to store the encoded video signal having the predetermined format; and
a network connecting part to control the digital TV signal and the encoded video signal to be transmitted to the portable computer.

29. The TV signal receiving module as recited in claim 28, wherein the portable computer further comprises:
a TV module connection terminal to which the TV signal receiving module is connected, wherein the TV module connection terminal is separated from and adjacent to a battery terminal to which the battery is connected.

30. The TV signal receiving module as recited in claim 28, wherein the TV signal receiving module is connected to the portable computer through the TV module connection terminal to transmit the TV signal to the portable computer.
